(19) United States
(12) Patent Application Publication
(10) Pub. No.: US 2017/0236027 A1
(43) Pub. Date: Aug. 17, 2017

(54) INTELLIGENT BIOMORPHIC SYSTEM FOR PATTERN RECOGNITION WITH AUTONOMOUS VISUAL FEATURE EXTRACTION

(71) Applicant: Brainchip Inc., Aliso Viejo, CA (US)

(72) Inventors: Peter AJ van der Made, Aliso Viejo, CA (US); Mouna Elkhatib, Irvine, CA (US); Nicolas Yvan Oros, Irvine, CA (US)

(21) Appl. No.: 15/435,264

(22) Filed: Feb. 16, 2017

Related U.S. Application Data
(60) Provisional application No. 62/296,010, filed on Feb. 16, 2016.

(51) Int. Cl. G06K 9/46; G06N 3/08; G06K 9/62; G06N 3/04

(52) U.S. Cl. CPC G06K 9/4628; G06N 3/049; G06N 3/088; G06K 9/6263

(57) ABSTRACT

Embodiments of the present invention provide a hierarchical arrangement of one or more artificial neural networks for recognizing visual feature pattern extraction and output labeling. The system comprises a first spiking neural network and a second spiking neural network. The first spiking neural network is configured to autonomously learn complex, temporally overlapping visual features arising in an input pattern stream. Competitive learning is implemented as spike time dependent plasticity with lateral inhibition in the first spiking neural network. The second spiking neural network is connected by means of dynamic synapses with the first spiking neural network, and is trained for interpreting and labeling output data of the first spiking neural network. Additionally, the output of the second spiking neural network is transmitted to a computing device, such as a CPU for post processing.

### CROSS-REFERENCE TO RELATED APPLICATION

This application claims the benefit of U.S. Provisional Patent Application No. 62/296,010, filed Feb. 16, 2016, the disclosure of which is incorporated by reference in its entirety.

### FIELD OF THE INVENTION

The present invention relates to automated pattern recognition using neural networks and more particularly to an autonomous visual feature learning and extraction system using spiking neural networks.

### BACKGROUND

The goal of visual feature extraction is to design a system that approaches the human ability to recognize visual features, such as objects and people, by means of autonomous extraction of patterns from video streams. Detecting objects in still and streaming images is useful in safety and security monitoring systems, unmanned vehicles, robotic vision, and behavior recognition. Accurate detection of objects is a challenging task due to lighting changes, occlusions, noise and convoluted backgrounds. Principal approaches use either template matching with hand-designed features or trained deep convolutional networks of simple artificial neurons and combinations thereof. The field of neural networks is aimed at developing intelligent machines that are based on mechanisms which are assumed to be related to brain function. Deep convolutional neural networks learn by means of a technique called back-propagation, in which errors between expected output values and actual output values are propagated back to the network by means of an algorithm that slowly updates synaptic weights with the intent to minimize errors over the course of many days and millions of samples. However, these methods are not flexible when dealing with previously unknown patterns or in the case of rapidly changing or flexible feature templates.

Artificial neural networks (ANN) are electronic network models simulating biological neural networks, hence they are designed to simulate the way in which the human brain processes information. As the brain learns from real-life experiences, the ANNs autonomously collect their knowledge by identifying the patterns and relationships in input data and learn (or trained) through experience and not from programming. Spiking Neural Networks (SNN) fall under third generation of neural networks, that more precisely simulate biological procedures. They are able to solve problems in a manner similar to a human brain, that is, using spikes to communicate events between neurons and gain their power and ability from the accurate neural structure of having synaptic connections between neurons.

A Spiking Neural Network (SNN) comprises a plurality of circuits, commonly referred to as ‘neurons’, including dendrites and a plurality of synapses that carry information in the shape of spikes to a target neuron. Spikes are defined as short pulses or bursts of electrical energy that have precise timing. Information is contained in the temporal as well as the spatial distribution of spikes. One dendrite of a neuron and one axon of another neuron are connected by means of a circuit that emulates the function of a biological structure called a synapse. The synapse also receives feedback when the post-synaptic neuron produces a spike which causes the efficacy of the connection to be modified. Pluralities of networked neurons are triggered in an indicative spatial and temporal activation pattern as a result of a specific input signal pattern, often referred to as population coding. Each input spike relates to an event. An event can be described as the occurrence of a specific frequency in an audio stream, the occurrence of a contrast transition in visual information, and a plethora of other physical phenomena that are detectable by the senses. Feedback of output spikes to synapses drives a process known as Spike Time Dependent Plasticity, commonly abbreviated as STDP, whereby the efficacy of a synapse is modified depending on the temporal difference of pre-synaptic and post-synaptic spikes. This process is thought to be also responsible for learning and memory functions in the brain. SNNs are also engaging more attention of researchers in image processing and computer vision applications.

Machine learning methods find its applicability in wide range of applications such as bioinformatics, computer vision, medical diagnosis, natural language processing, robotics, sentiment analysis, speech recognition and big data analysis. Machine learning methods implemented through spiking neural networks learn experience from a set of given inputs that contains patterns, and make input-driven predictions on unknown test data. These computer algorithms include supervised learning and unsupervised learning. The supervised learning algorithm involves presenting the system with example inputs and their desired outputs, and generating a rule that maps defined inputs to expected outputs. In contrast, in unsupervised learning, no labels are given to the learning algorithm, leaving it on its own to learn to extract patterns from the input data.

Image processing or video processing is one area where the machine learning finds its application. An observation in the form of an image or a video frame can be represented in many ways such as a map of color and intensity encoded pixels, vectors of intensity value per pixel, or as a set of edges, regions of particular shape etc. The machine learning algorithm in this case uses a cascade of many layers of nonlinear processing units for feature extraction and transformation. Each successive layer uses the output from its previous layer as input. The algorithm may be supervised or unsupervised and its applications include pattern analysis and classification.

Related studies propose vast applications of SNNs in image processing. Wu et al. proposed, in “Processing visual stimuli using hierarchical spiking neural networks”, hierarchical spiking neural networks to process visual stimuli. The model forms shapes of objects using local excitatory lateral connections and the firing rate of neurons. Girau et al. in “FPGA implementation of an integrate-and-fire LEGION model for image segmentation” utilized oscillatory integrate-and-fire neurons to the standard LEGION (Local Excitatory Global Inhibitory Oscillator Network) architecture to segment grey-level images. In “Clustering within Integrate-and-Fire Neurons for Image Segmentation”, Rowcliffe et al. reveals a development of an algorithm to produce self-organization of a purely excitatory network of Oscillatory Integrate-and-Fire (IF) neurons, receiving input from a visual scene. Pixels from an image are used as scalar inputs for the network, and segmented as the oscillating neurons are clustered into synchronized groups. These systems differ significantly in their implementation of the Spiking Neural Network proposed here. Rate encoded Spiking Neural Networks utilize the spiking rate of a neuron to transmit data, while oscillatory I&F networks treat neurons as oscillators, employing the phase of oscillation to express data. Both these methods are significantly slower than the neural processing system proposed here, which is a sparse Spiking Neural Network.

In traditional systems, a computer program loads a single frame from a video camera into memory and searches that frame for identifying features, predefined by a programmer. Each section of the image is compared to a template until a match is found and a percentage of the match is computed, along with its location. However, the problem with the traditional system is the use of cumbersome processes for identifying and recognizing known features and an inability of the system to learn new features.

In order to overcome the aforementioned limitations, the present invention provides a system having a hierarchical arrangement of two or more sparse spiking artificial neural networks for recognizing and labeling features in an input stream.

### SUMMARY

In a first aspect of the invention, a system for autonomous visual feature extraction is provided. The system comprises a hierarchical arrangement of a first sparse spiking neural network and a second sparse spiking neural network, said first spiking neural network learns and subsequently recognizes one or more visual patterns in an input stream and the second spiking neural network interprets and labels said one or more visual patterns recognized by the first artificial neural network. The first artificial neural network autonomously learns to recognize said one or more visual features through an unsupervised learning method, which is Spike Timing Dependent Plasticity (STDP) and lateral inhibition. The first artificial neural network and the second artificial neural network can be single layered or multi-layered spiking neural network. The first spiking neural network autonomously learns by means of spike time dependent plasticity and lateral inhibition to create a predetermined knowledge domain comprising a plurality of weights representing the learned visual patterns in the input stream. The second artificial neural network labels said one or more visual features by mapping spikes produced by the first Spiking Neural Network representing learned features into output labels within the predetermined knowledge domain. The first spiking neural network receives the input stream from a vision sensor via an input unit, such as an address event representation (AER) bus. The sensor encodes the input stream with spike address events and hence, transmits encoded spikes to the first spiking neural network. The input stream that can be fed to the system can be in real-time or in the form of recorded media. The first artificial neural network and the second artificial neural network comprise a plurality of digital neuron circuits interconnected by a plurality of synapse circuits. The second artificial neural network is configured to function in a supervised manner and is trained to produce input/output maps within the predetermined knowledge domain. The one or more output label generated by the system is transmitted to a computing device, such as a central processing unit, for post processing.

In a second aspect of the present invention, a method for autonomously extracting visual features by a neural network device is provided. The method comprises: feeding an input data stream to the neural network device; learning and subsequently recognizing one or more repeating features in the input data stream by a first spiking neural network present in the neural network device; sending, by the first artificial neural network, spikes representing said one or more features to a second artificial neural network arranged hierarchically with the first spiking neural network in the neural network device; labeling said one or more features by the second artificial neural network to generate one or more output labelled data. The first spiking neural network receives the input stream from a sensor that may include an image sensor, a video sensor, an artificial retina or an image source outside human perception such as an Infra-red, X-ray or an ultrasound device. The first artificial neural network and the second artificial neural network comprise a plurality of digital neuron circuits interconnected by a plurality of synapse circuits. The first artificial neural network and the second artificial neural network comprise a single layer or a multilayer of digital neuron circuits. The first artificial neural network autonomously learns to recognize said one or more repeating features in the input stream through an unsupervised mode of learning. The unsupervised mode of learning is performed using a spiking timing dependent plasticity method and lateral inhibition between neurons to create a predetermined knowledge domain comprising of a plurality of weights representing one or more learned features in the input stream. The second artificial neural network is configured to function in a supervised manner and is trained to produce input/output maps within a predetermined knowledge domain. The second artificial neural network transmits the output labels to a computing device, such as a central processing unit for post processing.

### BRIEF DESCRIPTION OF DRAWINGS

The preferred embodiment of the invention will hereinafter be described in conjunction with the appended drawings provided to illustrate and not to limit the scope of the invention, wherein like designation denote like element and in which:

FIG. 1 illustrates a schematic representation of an autonomous visual feature extraction system, in accordance with an embodiment of the present invention.

FIG. 2 illustrates a block diagram of the autonomous visual feature extraction device, in accordance with an embodiment of the present invention.

FIG. 3 illustrates an architecture of autonomous visual feature extraction device showing a first spiking neural network and a second spiking neural network, in accordance with an embodiment of the present invention.

FIG. 4 illustrates an artificial neuron array comprised in the first spiking neural network and the second spiking neural network.

FIG. 5 is a block diagram showing an artificial neuron present in the artificial neuron array.

FIG. 6 shows a graph output representing CAD system synapse PSP behavior and STDP variation used by the first spiking neural network, in accordance with an embodiment of the present invention.

FIG. 7 shows a diagrammatic representation of spike timing dependent plasticity implemented by the first spiking neural network in the system, in accordance with an embodiment of the present invention.

FIG. 8 illustrates a flowchart showing a method of autonomously extracting visual features, in accordance with an embodiment of the present invention.

### DETAILED DESCRIPTION

In the following detailed description of embodiments of the invention, numerous specific details are set forth in order to provide a thorough understanding of the embodiments of the invention. However, it will be obvious to a person skilled in art that the embodiments of the invention may be practiced with or without these specific details. In other instances well known methods, procedures and components have not been described in details so as not to unnecessarily obscure aspects of the embodiments of the invention.

Furthermore, it will be clear that the invention is not limited to these embodiments only. Numerous modifications, changes, variations, substitutions and equivalents will be apparent to those skilled in the art, without parting from the spirit and scope of the invention.

In an embodiment of the present invention, a system and a method for autonomous visual feature extraction is provided. The autonomous visual feature extraction is the process of extracting informative characteristics from an image. The system initially has no knowledge of content in an input stream. The system learns autonomously by repetition and intensity, and starts to find patterns in the input stream. The input stream can originate from any source, such as an image sensor like an artificial retina or from other sources that are outside of human perception such as radar or ultrasound images. The system learns to recognize features within a few second, just like a human would when looking at a scene. The system acquires information and learns without human supervision from the input stream which can be a visual input.

The system comprises a hierarchical arrangement of a first spiking neural network and a second spiking neural network implemented in a digital hardware. The first spiking neural network autonomously learns to recognize patterns in the input streams and the second spiking neural network performs data labeling for pattern recognized by the first spiking neural network.

The information transacted within the system is expressed as spikes, which are defined as short pulses of electrical energy that have precise timing. Autonomous learning by the first spiking neural network is performed through spike timing dependent plasticity process and lateral inhibition, and it occurs when a synaptic strength value within the system is increased or decreased as a result of the temporal difference of an input spike temporally related to a soma feedback output spike. The first spiking neural network autonomously learns to recognize repeating patterns in the input streams and thus performs autonomous feature extraction, and the second spiking neural network performs data labeling for patterns recognized by the first neural network. The known and labeled data is made available as an output to a microprocessor or a computer system. A level of noise may be injected as random values into the soma or dendrites of each neuron.

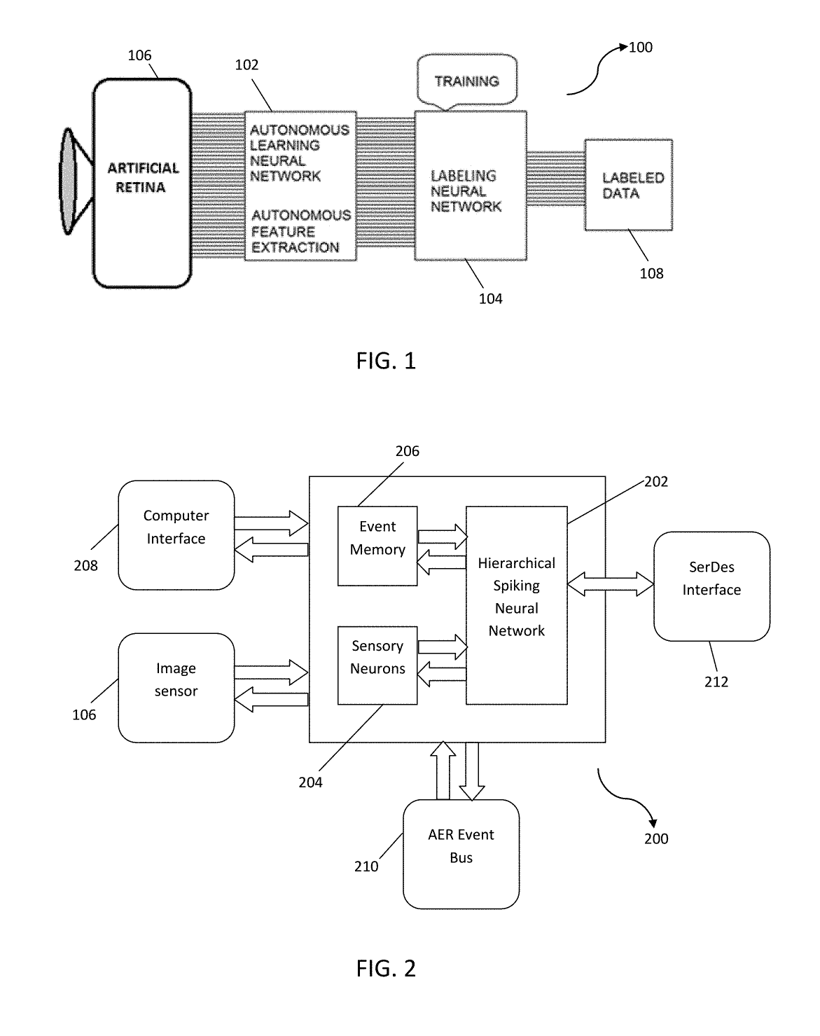

FIG. 1 illustrates a schematic representation of an autonomous visual feature extraction system, in accordance with an embodiment of the present invention. The autonomous visual feature extraction system 100 comprises a first spiking neural network 102 and a second spiking neural network 104. The first spiking neural network 102 comprises a plurality of digital artificial spiking neurons; each of the digital artificial spiking neurons is comprised of binary logic gates and is interconnected to other artificial spiking neurons through dynamic artificial synapses. In an embodiment, the first and the second spiking neural networks 102 and 104 respectively may include a single layer or multiple layers of digital neurons without departing from the meaning and scope of the present invention.

The plurality of digital artificial spiking neurons of the first spiking neural network 102 is connected by means of dynamic synapses to an image source 106 that provides a defined, but unlabeled pattern stream of data. This data is provided as a stream of temporal and spatially distributed spikes, encoded on an AER (Address Event Representation) bus. In an embodiment, the image source 106 is an artificial retina that represents contrast changes, and is comprised of defined but unlabeled pattern streams. For example, the artificial retina can be a DAVIS artificial retina. Spiking Neural Network (SNN) 102 autonomously learns any repeating patterns that are present in the input spike stream, within three to seven repetitions of such patterns. Neurons in SNN 102 respond with a spike when a learned pattern is detected in the stream of spiking data 106. Output spikes are transmitted to neurons in the second Spiking Neural Network 104. SNN 104 has been trained to label the output spikes received from SNN 102 as labeled output data. For instance, in one embodiment of the invention the image sensor was aimed at a series of fast moving objects. The image sensor transmitted contrast changes in the form of spikes to SNN 102. SNN102 learned the repeating patterns within seven repetitions of these objects moving through the visual field of the sensor, and started to produce selective spikes in response to the relative position of each object. The second Spiking Neural Network 104 received these spikes from SNN 102 and was trained to label objects passing in specific positions. The labeled output data 108 was sent to a computer program, which counted the number assertions as of objects passing in each position with an accuracy of better than 98%.

Competitive learning is implemented as spike timing dependent plasticity and lateral inhibition in the first spiking neural network 102. The first spiking neural network 102 is configured to learn autonomously by applying the input stream to create a knowledge domain comprised of a plurality of weights representing learned features arising in the input stream. The system 100 is capable of autonomously learning complex, temporally overlapping features arising in the input pattern stream. The learned data in the form of output spikes from the first spiking neural network 102 is then passed to the second spiking neural network 104. The second spiking neural network 104 has a monitoring means that is trained to identify output which meets the predetermined criteria; the second spiking neural network 104 is a labeling artificial neural network which produces input-output map within a predetermined knowledge domain. The output of the second spiking neural network 104 is hence a labeled data 108. Therefore, the second spiking neural network 106 connected by means of dynamic synapses to the first spiking neural network 102 is trained to interpret and label the output data of the first spiking neural network 102, thus generating a labeled output data 108.

FIG. 2 illustrates an autonomous visual feature extraction device, in accordance with an embodiment of the present invention. The autonomous visual feature extraction device 200 comprises a hierarchical spiking neural network 202 connected to a plurality of sensory neurons 204. The hierarchical spiking neural network 202 comprises the first spiking neural network 102 configured to perform the function of autonomous learning to recognize a feature (represented as a repeating pattern or a combinations of repeating patterns) in an input stream, and the second spiking neural network 104 configured to perform function of labeling the spikes produced by Spiking neural network 102 and representing recognized features. The sensory neuron 204 receives an input stream from the one or more image sensors 106. The sensor 106 may include and is not limited to analog vison sensor or digital vision sensors, for example an artificial retina. Any input spike received by the first spiking neural network is an event. Events associated with the hierarchical spiking neural network 202 are stored in a distributed event memory 206. The events may include the features or pattern data recognized by the first spiking neural network and the output data labeled by the second spiking neural network.

The output of the autonomous visual feature extraction device 200 is connected to a computer interface 208 for transmitting the output of the autonomous visual feature extraction device 200 to a computing device, such as a CPU or a microprocessor. An Address Event Representation (AER) event bus 210 is provided with the autonomous visual feature extraction device 200 for communication of spike events to external devices, such as additional Spiking Neural Networks. A Serializer/Deserializer (SerDes) interface 212 communicates with the autonomous visual feature extraction device 200 to provide data transmission over a single/differential line in order to minimize the number of Input/Output pins and interconnects.

In an embodiment of the present invention, the image sensor 106 connected to the autonomous visual feature extraction device 200 is an artificial retina. The artificial retina has an AER (Address Event Representation) interface, which is corresponding to the AER bus used in the autonomous visual feature extraction device 200. The address event bus 210 has become an industry standard. Rather than outputting frames of video, each pixel outputs one or more spikes, whenever the contrast changes, and the address (row and column number) of that pixel is transmitted over the AER bus at the time the contrast change occurs. A contrast change can be caused by any movement, changing lighting conditions etc. Spike events are transmitted over the address event representation bus 210 at a rate of 50 million events per second. In the present embodiment the autonomous visual feature extraction device 200 can process 100 million events per second.

In an exemplary situation, the autonomous visual feature extraction device 200 autonomously learns to identify objects moving through the vision field of the image sensor 106. Movement causes contrast changes which are transmitted as spike addresses on the AER bus by the Artificial retina circuit. The autonomous visual feature extraction device 200 incorporates circuitry to decode the AER bus, and restore the original spikes that are input to the first spiking neural network 102. It learns any spike patterns that repeat, and starts responding to those patterns by generating spikes. The second labeling neural network 104 is trained to label the spikes that are generated by the first spiking neural network. An external computer program can be used to count the occurrences of spikes in the second spiking neural network which represent the recognized objects.

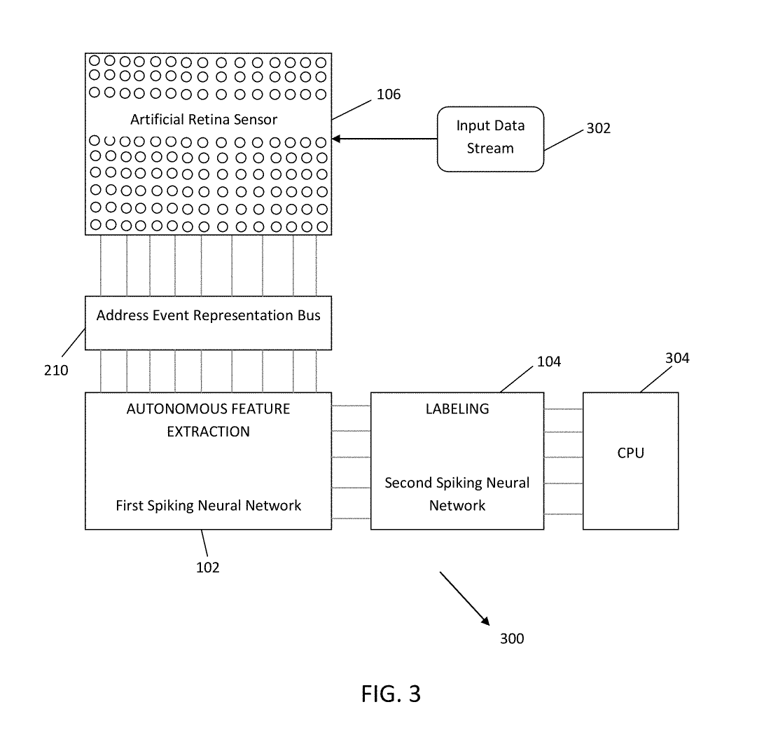

FIG. 3 illustrates an architecture of autonomous visual feature extraction device showing a first spiking neural network and a second spiking neural network, in accordance with an embodiment of the present invention. The architecture 300 shows a hierarchical arrangement of the autonomous visual feature extraction device 200 comprising the first spiking neural network 102 and the second spiking neural network 104, configured in a manner that the first spiking neural network 102 receives an input data stream 302 over the AER bus 210 from the image sensor 106. As mentioned earlier, the image sensor 106 can be an artificial retina, such as an artificial retina camera.

The image sensor, e.g. the artificial retina camera, is connected via the Address Event Representation (AER) bus 210 to the first spiking neural network 102. The first spiking neural network 102 autonomously learns to extract features from the input stream 302 and sends spikes to the second spiking neural network 104. The second spiking neural network 104 identifies the output from the first spiking neural network 102 and labels the extracted features. The labeled data is then output to a control and processing unit 304.

Alternatively, a prerecorded input stream 302 can be connected to the AER bus 210 instead of an artificial retina. On occurrence of an event, such as a contrast change, each pixel outputs a spike event through the AER bus, which is decoded back to a spike event and input to the first spiking neural network 102. The encoded spike is called as an address event. The encoded information uniquely identifies the occurrence of a spike at a specific time and spatial location; the information includes the location, encoded as address and the time of occurrence is preserved in the transmission time of the address. The encoded spikes are communicated via the address event representation (AER) bus 210. The first artificial neural network 102 receives the output spikes from the artificial retina 106 and responds to features originally contained in the image. The first artificial neural network 102 learns to recognize one or more features and the device 200 starts identifying one or more learned features present in the input stream 302.

The one or more identified features are then labeled by the second artificial neural network 104 to generate a labeled output data. The labeled output data is then communicated to the control and processing unit 304 of a computer system. Therefore, the first spiking neural network 102 recognizes the changing and repeated features in the input image while the second spiking neural network 104 labels the recognized features.

Alternatively, the first spiking neural network 102 is configured to learn autonomously the repeating patterns in the input data stream 302, using a learning method, such as synaptic time dependent plasticity and lateral inhibition. The recorded data stream may comprise the recorded spikes from a spiking image sensor such as a dynamic vision sensor. Thereby, a knowledge domain is created that comprises of a plurality of weights that represent learned features in the input data stream 302.

An example of an event generation can be: the input to the first spiking neural network 102 is provided by an artificial retina or other means to convert the contrast transformation within an image into precision timed spikes. Example of the image sensor may be a DAVIS artificial retina that is commercially available from Inilabs and which can generate temporal and spatial spike patterns that represent contrast changes in pixels with a time resolution of 1 microsecond (1*10⁻⁶ second). These input spike patterns are transferred over the Address Event Representation (AER) bus.

Temporal and spatial distributed output spikes from the artificial retina array 106 are then forwarded as an input to the first spiking neural network 102 that further performs the autonomous feature extraction function. Autonomous feature extraction is also known as unsupervised feature learning and extraction. The first spiking neural network 102 learns the features in the input spike stream that characterizes an applied dataset through a function known as Spike Time Dependent Plasticity (commonly abbreviated as STDP). STDP modifies the characteristics of the synapses depending on the timing of neural input spikes to neural output spikes. Further, STDP is an unsupervised learning rule and it utilizes lateral inhibition so that neurons learn unique features. In lateral inhibition, the first neuron that responds to a specific pattern inhibits other neurons within the same lateral layer prohibiting those neurons to learn same features. In an exemplary embodiment, the applied dataset may contain the features of pixels that are modified at a given instant. Thus, the autonomous feature extraction module, which is the first spiking neural network 102, learns the features of objects that move through the visually sensory areas of the camera. Further, the spike time dependent plasticity learning rule may be switched off, when all the desired features have been learned.

After the first spiking neural network 102 has learned the one or more features in the input pattern, the first spiking neural network 102 feeds temporally and spatially distributed spikes on each occurrence of a learned pattern in the input stream, representing the learned and recognized features, to the second spiking neural network 104. The second spiking neural network 104 can be trained in a supervised manner to map the recognized features into output labels. For instance, the output labels are indicative of moving objects that the first spiking neural network 102 has learned to recognize. Thereafter, the output labels can be transmitted to an external device like a Central Processing Unit (CPU) 304 for post-processing.

The second spiking neural network 104 is trained to identify outputs which meet predefined criteria as the outputs are produced. The second spiking neural network 104 is further trained to produce input-output maps within the predetermined knowledge domain, wherein the identification of outputs is indicative of production of useful information by the autonomous visual feature extraction device 200. The outputs of the first spiking artificial neural network 102 are identified by the second spiking neural network 104 that represents acceptable labeled data.

Conclusively, the autonomous feature extraction system 100 implements the neural networks for pattern features extraction. Feature extraction is a process of mapping original features (measurements) into fewer features which include main information of a data structure. Unsupervised methods are applied in feature extraction when a target class of input patterns is unknown.

In an embodiment, all processes in the autonomous visual feature extraction system 100 are performed in parallel in digital hardware. The system 100 can be applied to autonomously extract features from a variety of vision sensors. The input data stream 302 is received in the form of binary spikes. The data 302 may be received in real-time or in the form of a recording. Once the first spiking neural network 102 has learned the features present in the input stream 302, it is capable of recognizing these features. The learned properties of the digital neurons and synapses in the first spiking neural network 102 can be stored externally or locally in a library file stored in the event memory. The thus created library file can be uploaded by other similarly configured systems in order to instantaneously assimilate the learned features.

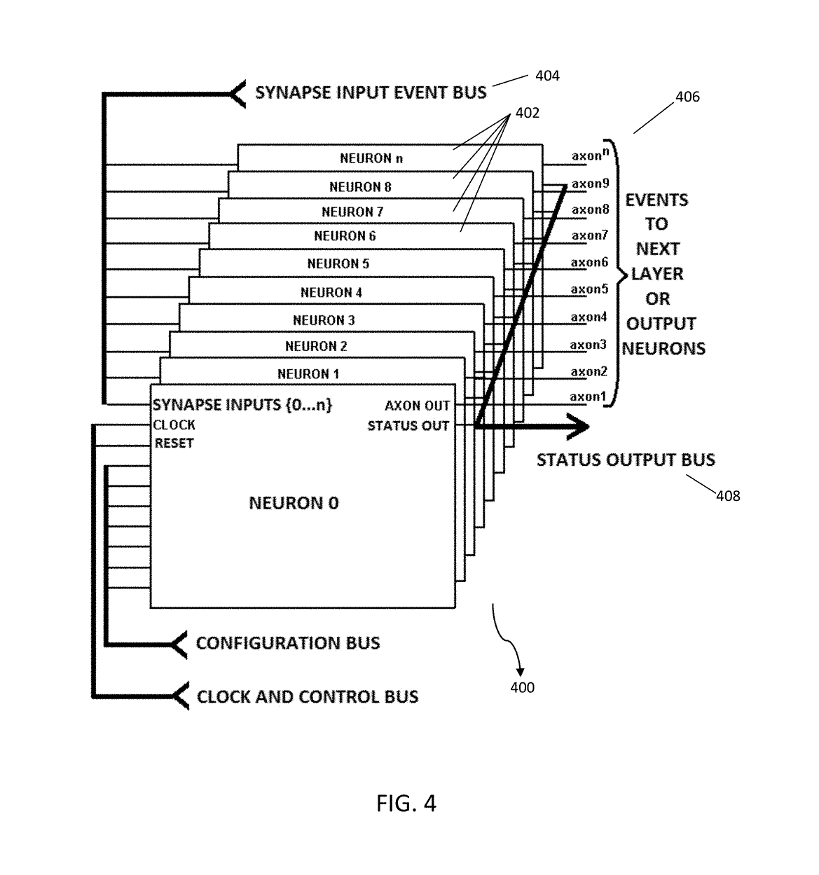

FIG. 4 illustrates an artificial neuron array comprised in the first spiking neural network and the second spiking neural network. The artificial spiking neural networks comprise arrays 400 of artificial digital neurons. Each of the first spiking neural network 102 and the second spiking neural network 104 comprises of a plurality of artificial neurons 402 forming an artificial neuron array 400. The digital neurons 402 present in the array 400 are externally connected where each synapse input and soma output is accessible. The digital neurons 402 {0 . . . n} are connected to each other via digital synapses and receive a corresponding synaptic input through a number of synaptic circuits via a synapse input event bus 404. The output of the plurality of synapses is integrated by dendrite circuits and a soma circuit. The output of the soma circuit is applied to the input of an axon circuit. Each of the digital neurons 402 present in the array 400 consists of an axon circuit 406. The axon circuit 406 emits one or more output spikes governed by the strength of the soma output value. From the axon circuit 406, events are generated for the next layer of digital neurons 402, or to output neurons 402 in case the last neuron layer is an output layer, via status output bus 408. The output spike of the axon circuit 406 is transmitted to the plurality of connected synapses using a proprietary communication protocol in the next layer.

A digital neuron 402 consists of dendrites that receive one or more synaptic inputs and an axon that shapes an output spike signal. Neurons are connected through synapse that receives feedback from the post-synaptic neuron which causes the efficacy of the connection to be modified. The output of the plurality of synapses is integrated by dendrite circuits and a soma circuit. The output of the soma circuit is applied to the input of an axon circuit. The axon circuit emits one or more output spikes governed by the soma output value. The output spike of the axon circuit is transmitted to the plurality of synapses in the next layer. Autonomous learning occurs when a synaptic strength value within the system is increased or decreased as a result of a temporal difference of an input spike temporally related to a soma feedback output spike. After several repetitions the synapses become potentiated such that the neuron responds to only one particular pattern. Each of the first digital spiking neural network 102 and the second digital spiking neural network 104 comprises a plurality of digital artificial neurons connected to each other through digital synapses, and the first and second spiking neural networks are connected as a hierarchical artificial neural network in the system 100.

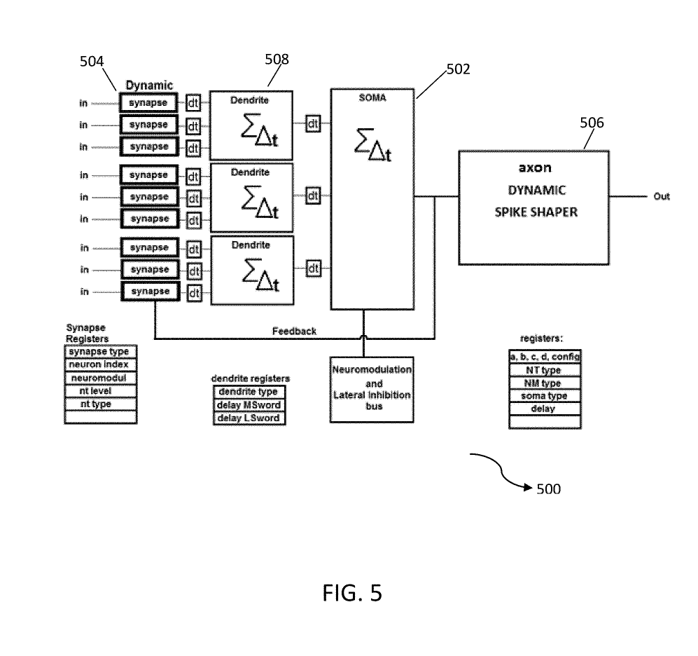

FIG. 5 is a block diagram showing an artificial neuron present in the artificial neuron array. The artificial neuron 500 comprises a soma circuit 502, a plurality of synapse circuits 504 designated within and an axon circuit 506. There is no theoretical limitation to the number of synapses that can be connected to the soma circuit 502. An integration circuit is constructed from circuits that add the synaptic weights 504 that are incorporated within the dendrite circuit 508. The number of connected synapse circuits 504 is therefore flexible. The integrated sum is input to the soma circuit 502. Soma control constitutes a circuit that increases the threshold potential for a period after the soma has fired. The output of the soma circuit 502 is applied to the input of the axon circuit 506. The axon circuit 506 emits one or more output spikes governed by the strength of the soma output value.

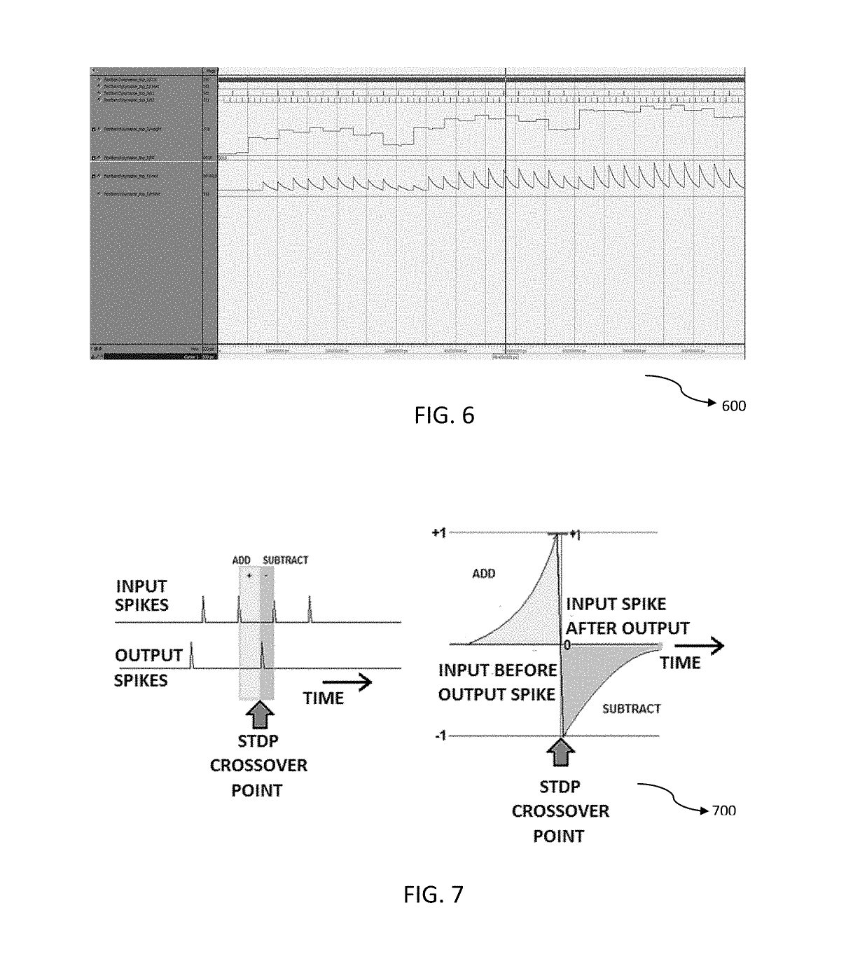

FIG. 6 shows a graph output representing CAD system synapse PSP behavior and STDP variation used by the first spiking neural network, in accordance with an embodiment of the present invention. The graph output 600 shows behavior of a synapse Post-Synaptic Potential (PSP) and an STDP weight variation as a result of presynaptic spikes and post-synaptic spikes. PSP (post-synaptic potential) is a value that expresses a temporary change in the electric polarization of a digital neuron. The postsynaptic potential can lead to the firing of a new spike impulse.

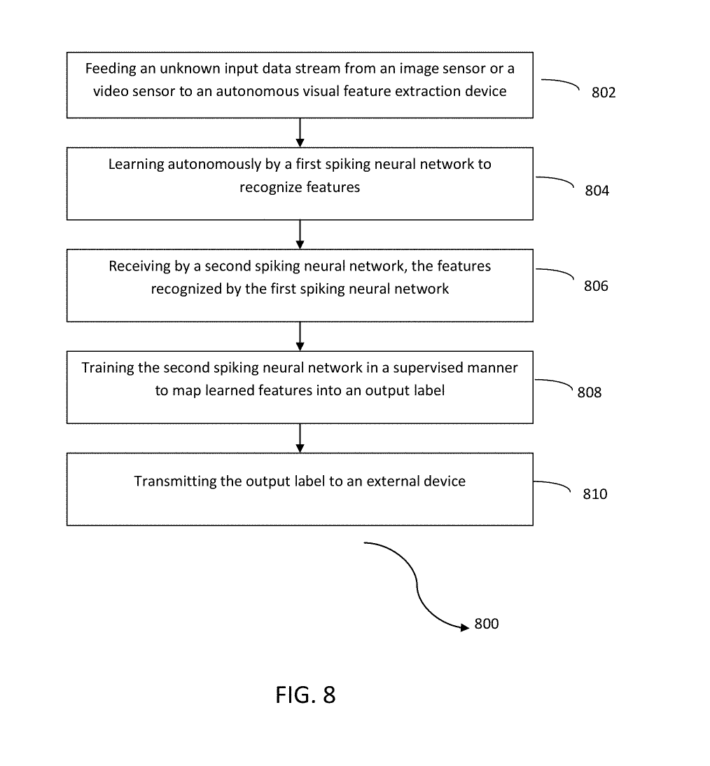

FIG. 7 shows a diagrammatic representation of spike time dependent plasticity implemented by the first spiking neural network in the system, in accordance with an embodiment of the present invention. The representation 700 shows spike time dependent plasticity used by the first spiking neural network 102 to autonomously learn repeating patterns for feature extraction and recognition. Feedback of output pulses to synaptic inputs drives a process known as spike time dependent plasticity, commonly abbreviated as STDP, whereby the strength of a synapse is modified depending on the temporal difference of input to output pulses. This process is responsible for learning and memory functionalities in the first spiking neural network 102 of the system 100.

In an embodiment, all processes are performed in parallel in a digital hardware. Such as, a synapse circuit performs the functions that are known to occur in a biological synapse, namely the temporal integration of input spikes, modification of the ‘weight’ value stored in the synapse by the STDP circuit, decay of a post-synaptic potential value, and the increase of this post-synaptic potential value when a spike is received. A dendrite circuit performs a function that is known to occur in biological dendrites, namely the integration of the post-synaptic potential value output by a plurality of synapses. A soma circuit performs a function that is known to occur in biological neurons, namely the integration of values produced by two or more dendrite circuits. The axon is also performing a function known to occur in biological neurons, namely the creation of one or more spikes, in which each spike is a short burst of electrical energy also known as a pulse.

Each of the first spiking neural network 102 and the second spiking neural network 104 is composed of the first plurality of artificial neurons that are connected to other artificial neurons via a second plurality of configurable synapse circuits. Both the connectivity and the strength of synapses are configurable through digital registers that can be accessed externally. The weight value stored in the synapse changes over time through application of the STDP learning rule, which is implemented in digital hardware.

FIG. 8 illustrates a flowchart showing a method for autonomously extracting visual features, in accordance with an embodiment of the present invention. The method 800 comprises feeding an input data stream containing unknown patterns from a source such as an image sensor or a video sensor to an autonomous visual feature extraction device, at step 802. The image sensor provides encoded spikes with its address to a first spiking neural network of the autonomous visual feature extraction device via an address representation bus. The first spiking neural network comprises a plurality of digital artificial spiking neurons; each of the plurality of digital spiking neurons comprises of binary logic gates and is interconnected to other artificial spiking neurons through dynamic artificial synapses. The image sensor provides a stream of temporally and spatially distributed spikes, comprising of defined but unlabeled pattern streams.

At step 804, autonomous learning and recognition by the first spiking neural network takes place. The first spiking neural network 102 is configured to learn autonomously by applying the input data stream, by means of a learning method known as spike time dependent plasticity and lateral inhibition, thereby creating a knowledge domain comprised of a plurality of weights representing learned and recognized features arising in the input data stream. The first spiking neural network recognizes one or more patterns or features in the input data stream. At step 806, information consisting of one or more recognized pattern features is passed to the second spiking neural network 104 that comprises a monitoring means.

At step 808, the second spiking neural network 104 labels the recognized features received from the first spiking neural network 102. The second spiking neural network 104 is trained to identify output from the first spiking neural network 102 that meets a predetermined criterion. The second spiking neural network 104 is an artificial neural network that produces input-output map within a predetermined knowledge domain. Therefore, output of the second spiking neural network 104 is a labeled data. At step 810, the labeled data or the labeled features are sent to a computing device, such as a central processing unit (CPU) for post processing.

In an embodiment of the present invention, the system can be applied to autonomously extract features from spiking sensors, such as visual features from the output of an artificial retina. The data is received in real-time but may also be in the form of a recording. Once the system has learned features present in the input stream, it is capable of recognizing these features. The learned properties of the digital neurons and synapses can be stored externally or locally in a library file. The thus created library file can be uploaded by other similarly configured systems in order to instantaneously assimilate the learned features.

The autonomous visual feature extraction system and a method can be used in large number of applications including surveillance and security cameras, collision avoidance system in road vehicles and unmanned aerial vehicle (UAV), anomaly detection, medical imaging, audio processing and many other applications.

1. A system for autonomous visual feature extraction, the system comprising:
a hierarchical arrangement of a first spiking neural network and a second spiking neural network, said first spiking neural network recognizes and learns one or more visual patterns in an input stream and the second spiking neural network interprets and labels said one or more visual patterns recognized by the first artificial neural network.

2. The system of claim 1, wherein the first spiking neural network autonomously learns to recognize said one or more visual patterns through an unsupervised learning method.

3. The system of claim 2, wherein the unsupervised learning method is spike time dependent plasticity and lateral inhibition.

4. The system of claim 1, wherein the first spiking neural network and the second spiking neural network is a single layered or a multilayered spiking neural network.

5. The system of claim 1, wherein the first spiking neural network autonomously learns by means of spike time dependent plasticity and lateral inhibition to create a predetermined knowledge domain comprising a plurality of weights representing the learned visual patterns in the input stream.

6. The system of claim 1, wherein the second spiking neural network labels said one or more visual patterns by mapping learned patterns into output labels within the predetermined knowledge domain.

7. The system of claim 1, wherein the first spiking neural network receives the input stream from a sensor via an input unit, such as an address event representation bus.

8. The system of claim 7, wherein the sensor encodes the input stream with spike address events and hence, transmits encoded spikes to the first spiking neural network.

9. The system of claim 7, wherein the sensor may include an image sensor, a video sensor, an artificial retina or an image source outside human perception such as an X-ray or an ultrasound.

10. The system of claim 1, wherein the input stream is in real-time or recorded media.

11. The system of claim 1, wherein each of the first spiking neural network and the second spiking neural network comprises a plurality of digital neuron circuits interconnected by a plurality of digital synapse circuits.

12. The system of claim 1, wherein the second spiking neural network is configured to function in a supervised manner and is trained to produce input/output maps within the predetermined knowledge domain.

13. The system of claim 1, wherein said one or more output labels are transmitted to a computing device, such as a central processing unit, for post processing.

14. A method for autonomously extracting visual features by a neural network device, the method comprising:
feeding an input data stream to the neural network device;
recognizing and learning one or more features in the input data stream by a first spiking neural network present in the neural network device;
sending, by the first spiking neural network, said one or more features to a second spiking neural network arranged hierarchically with the first spiking neural network in the neural network device; and
labeling said one or more learned features by the second spiking neural network to generate an output label data.

15. The method of claim 14, wherein the first spiking neural network receives the input stream from a sensor that may include an image sensor, a video sensor, an artificial retina or an image source outside human perception such as an X-ray or an ultrasound.

16. The method of claim 14, wherein the first spiking neural network and the second spiking neural network comprise a plurality of digital neuron circuits interconnected by a plurality of synapse circuits.

17. The method of claim 14, wherein the first spiking neural network and the second spiking neural network are a single layer or a multilayer of digital neuron circuits.

18. The method of claim 14, wherein the first spiking neural network autonomously learns to recognize said one or more features in the input stream through an unsupervised mode of learning.

19. The method of claim 18, wherein the unsupervised mode of learning is a spiking time dependent plasticity method and the lateral inhibition to create a predetermined knowledge domain comprising of a plurality of weights representing one or more learned features in the input stream.

20. The method of claim 14, wherein the second spiking neural network is configured to function in a supervised manner and is trained to produce input/output maps within the predetermined knowledge domain.

21. The method of claim 14, wherein the second spiking neural network transmits the output labels to a computing device, such as a central processing unit, for post processing.
